(19) United States
(12) Patent Application Publication
(10) Pub. No.: US 2004/0254337 A1
(43) Pub. Date: Dec. 16, 2004

(54) Process for the polymerisation of epoxy resins

(76) Inventor: Jan Hermen Hendrik Meurs, CM Amsterdam (NL)

Correspondence Address: Donald F Haas, Shell Oil Company, Intellectual Property, PO Box 2463, Houston, TX, 77252-2463, US

(21) Appl. No.: 10/495,933

(22) PCT Filed: Nov. 18, 2002
(86) PCT No.: PCT/EP02/12895

(30) Foreign Application Priority Data
Nov. 19, 2001 (EP) 01 309 728.2

(51) Int. Cl. C08G 65/04

(52) U.S. Cl. 528/421; 568/679

(57) ABSTRACT

A process for the preparation of a resinous composition involving contacting a polyol with a compound containing at least 2 epoxy groups in the presence of hydrogen fluoride.

The present invention relates to a process for the preparation of a resinous composition.

### BACKGROUND OF THE INVENTION

Epoxy resins are especially useful for preparing resinous compositions. Epoxy resins are resins containing two or more epoxide groups per molecule. A well known resin is the diglycidyl ether of diphenylolpropane which commercially is generally produced by the condensation of epichlorohydrin with diphenylolpropane. Upon curing, a resinous composition is obtained. Generally, amine containing compounds are used for curing.

Epoxy resins are used for preparing resinous compositions for a wide range of applications. The most important applications are surface coatings and engineering. In many of these applications, it is desirable to be able to influence the properties of the resinous composition in a simple and effective way.

### SUMMARY OF THE INVENTION

Surprisingly, it has now been found possible to prepare resinous compositions in such a way that the properties of the resinous composition can be changed in a simple and effective way. The resinous compositions obtained varied from hard to rubbery. An additional advantage of the resinous compositions according to the present invention is that they can be prepared in the absence of amine containing curing agents. Amine containing curing agents tend to give discolouring in the course of time. A special advantage of the present invention is that the resinous compositions can be prepared at relatively low temperature. Additionally, it was found that the process can be carried out in the

presence of a limited amount of water, such as less than 1000 ppm of water.

The present invention relates to a process for the preparation of a resinous composition which process comprises contacting a polyol with a compound containing at least 2 epoxy groups in the presence of hydrogen fluoride.

Further, the present invention relates to a resinous composition obtainable by a process according to the present invention.

### DETAILED DISCUSSION OF THE INVENTION

In the process according to the present invention, the catalyst is hydrogen fluoride. The hydrogen fluoride can be added as such or can be formed in-situ. Hydrogen fluoride can be formed in-situ for example by the use of compounds from which hydrogen fluoride can be separated off at reaction conditions. Preferably, the hydrogen fluoride is added as such to the process of the present invention.

The hydrogen fluoride is present in such amount that it catalyses the reaction of the initiator with the one or more alkylene oxides. The amount needed to catalyse the reaction depends on the further reaction circumstances such as the initiator used, the alkylene oxide present, the reaction temperature, further compounds which are present and which may react as co-catalyst, and the desired product. Generally, the hydrogen fluoride will be present in an amount of from 0.0005 to 10% wt, more preferably of from 0.001 to 5% wt, more preferably of from 0.002 to 1% wt, based on total amount of initiator and alkylene oxide.

It has been found that the process according to the present invention can be improved even further by the additional presence of compounds comprising at least one element chosen from Group 3a, 4a and 4b of the Periodic Physics, 63rd Edition, 1982-1983). It is thought that these compounds act as co-catalysts. It was found that the presence of such compounds gives an increased yield of alkylene oxide converted per gram of hydrogen fluoride. Carbon can be present in the compounds but does not need to be present, as both organic and inorganic compounds were found which improved the performance of the hydrogen fluoride. Preferred compounds comprise at least one element chosen from the group consisting of boron, silicon, titanium and aluminium. Further, it was found that preferred compounds acted as Lewis acids with respect to hydrogen fluoride. Therefore, a preferred group of compounds present in addition to hydrogen fluoride, are compounds accepting an electron pair from hydrogen fluoride. Specific compounds giving good results were found to be boric acid, glass, titanium(IV)methoxide, aluminium(III)isopropoxide, alkylsilicates and alkylborates. Preferably, a compound is present comprising boron and/or silicon. Most preferably, a compound containing boron is present. Boron containing compounds were found to give the highest increase in activity of the hydrogen fluoride. Preferred organic compounds comprising boron and/or silicon are chosen from the group of compounds consisting of silicon hydrides contacted with one or more organic compounds and boron containing acids contacted with one or more organic compounds.

The process according to the present invention may be carried out in the presence or in the absence of an inert solvent. Suitable inert solvents are heptane, cyclohexane, toluene, xylene, diethyl ether, dimethoxyethane and/or chlorinated hydrocarbon (such as methylene chloride, chloroform or 1,2-dichloro-propane). The solvent, if used, is generally used in an amount of from 10 to 30%.

solvent, if used, is generally used in an amount of from 10 to 30%.

The reaction times range from a few minutes to several days. Generally, the reaction will take of from a few minutes to a few hours.

The process can be carried out continuously, in a batch process or in a semi-batch process.

A wide range of polyols can be used in the process according to the present invention. Furthermore, mixtures of one or more polyols can be used. For the present invention, polyols are compounds containing at least 2 hydroxyl groups. Preferred polyols for use in the present invention are one or more polyols chosen from the group consisting of ethylene glycol, propylene glycol, glycerol, sorbitol and alkoxylated polyols. Alkoxylated polyols are preferred and are obtained by reacting a hydroxyl group containing initiator with one or more alkylene oxides in the presence of a suitable catalyst. More specifically, the alkoxylated polyols are obtained by contacting one or more compounds chosen from the group consisting of diethylene glycol, dipropylene glycol, glycerol, di- and polyglycerols, pentaerythritol, trimethylolpropane, sorbitol and mannitol, with propylene oxide or a mixture of propylene oxide and ethylene. The alkoxylated polyols can finally have been reacted with ethylene oxide only, so-called ethylene oxide tipping. The molecular weight of the alkoxylated polyol preferably is of from 1000 to 100,000, more specifically of from 1,000 to 50,000, most specifically of from 2,000 to 10,000. The number average functionality preferably is of from 1 to 10, more specifically of from 2 to 6, most specifically of from 2 to 4.

If a mixture of polyols is used in the present invention, such mixture preferably contains an alkoxylated polyol in combination with a polyol which has not been alkoxylated.

The compound containing at least 2 epoxy groups for use in the present invention can be any compound containing at least 2 epoxy groups. Preferably, the epoxy group containing compound has a number average molecular weight of at least 100, more preferably at least 200. The epoxy group containing compound for use in the present invention can be an epoxidized polyether polyol. Epoxidized polyether polyols are polyether polyols in which on average at least 2 of the terminal hydroxyl groups have been replaced by an epoxy group. The hydroxyl group is preferably replaced by a glycidyl ether group. The latter is suitably obtained by reacting the polyether polyol with epichlorohydrin. Examples of preferred epoxy group containing compound for use in the present invention are epoxidised soya bean oil and epoxidised linseed oil, and resins based on epichlorohydrin and 2,2-diphenylolpropane (bisphenol A), epoxy cresol-novolak resins, 2,2′-methylene bisphenol (bisphenol F) resins, epoxy phenol-novolak resins, polynuclear phenol-glycidyl ether derived resins and cycloaliphatic epoxy resins. Preferably, the epoxy group containing compound comprises at least one aromatic ring. More preferably, the epoxy group containing compound is derived from 2,2-diphenylolpropane (bisphenol A). Most preferably, the epoxy group containing compound is a diglycidyl ether of bisphenol A.

It was found that the products prepared according to the present invention could range from hard to soft rubbery depending on the ratio between the epoxy group containing compound and the polyol. Preferably, the weight ratio of polyol to epoxy compound is of from 10:90 to 90:10, more specifically of from 20:80 to 80:20. It was found that resinous compositions according to the present invention could have a glass transition temperature ranging of from −100° C. to 150° C.

A further advantage of the products of the present invention are their good mechanical properties and solvent resistance.

It is possible to carry out the process according to the present invention in the further presence of a volatile compound. The volatile compounds can be incorporated as such into the resinous compositions of the present invention, or compounds can be incorporated which produce volatile compounds in-situ. Volatile compounds which are especially suitable are carbon dioxide and nitrogen. If the resinous composition according to the present invention contains volatile compounds, either because they were incorporated as such or because they were produced during preparation of the composition, a solid resinous foam can be obtained. If a solid resinous foam is to be produced, the composition preferably contains at least 1 part by weight of volatile compound per 100 parts by weight of epoxy compound containing at least 2 epoxy groups during preparation.

The process according to the present invention can be carried out at a temperature of less than 200° C., more specifically of from 0 to 150° C., more specifically of from 10 to 100° C., most specifically at ambient temperature.

In order to influence the properties of the resinous composition obtained, further compounds can be present such as fillers, solvents, diluents, plasticizers, accelerators, curatives and tougheners. For several applications, the presence of filler is especially advantageous.

The present invention is hereinafter exemplified.

### EXAMPLE

The polyether polyol used in the present invention was prepared from glycerine and propylene oxide. Its average molecular weight was 3500. Different amounts of polyether polyol were mixed with different amounts of epoxy resin. The epoxy resin is the diglycidylether of diphenylolpropane. The mixture obtained was degassed under vacuum. Catalyst solution (1 gram of 10% wt HF solution in polyol) was added together with 50 microliter of trimethylborate and stirred until the mixture was homogeneous. At ambient temperature, curing started after from 0 to 15 minutes. The products obtained were crystal clear.

| amount polyol (g) | amount resin (g) | properties |
|---|---|---|
| 20 | 80 | hard |
| 60 | 40 | rubbery |

1. A process for the preparation of a resinous composition comprising contacting a polyol with a compound containing at least two epoxy groups in the presence of hydrogen fluoride.

2. The process of claim 1; in which the compound containing at least 2 epoxy groups is a diglycidyl ether of diphenylolpropane.

3. The process of claim 1 in which a compound comprising boron is contacted with the polyol and the compound in the presence of hydrogen floride.

4. The process of claim 1 in which a filler is contacted with the polyol and the compound in the presence of hydrogen floride.

5. The process of claim 1 in which the polyol is an alkoxylated polyol.

6. The process of claim 1 in which the process is carried out at a temperature of from 0° C. to 150° C.

7. The process of claim 6 in which the process is carried out at ambient temperature.

8. The process of claim 1 in which a volatile compound is contacted with the polyol and the compound in the presence of hydrogen floride.

9. A resinous composition obtained by contacting a polyol with a compound containing at least two epoxy groups in the presence of hydrogen fluoride.

10. The process of claim 5 in which the alkoxylated polyol has a number average molecular weight to from 1000 to 100,000.

11. The process of claim 1 in which the reaction mixture is placed under vacuum to remove volatile compounds.
